(19) United States
(12) Patent Application Publication
(10) Pub. No.: US 2016/0170939 A1
(43) Pub. Date: Jun. 16, 2016

(54) SYSTEM AND METHOD FOR SOCIAL FOOD CONTENT SHARING

(71) Applicants: Qian Chen, San Jose, CA (US); Javier Marques, San Jose, CA (US)

(72) Inventors: Qian Chen, San Jose, CA (US); Javier Marques, San Jose, CA (US)

(21) Appl. No.: 14/569,666

(22) Filed: Dec. 13, 2014

(51) Int. Cl. G06F 17/21; G06F 17/24; G06Q 30/06

(52) U.S. Cl. CPC G06F 17/212; G06Q 30/0643; G06F 17/248; G06Q 50/01

(57) ABSTRACT

A system and method for sharing food related content on an online social network. The method enables a foodie user to take the role of an explorer or a creator, share a wide range of food related content on a virtual platform, and interact with other users. The method covers numerous food related content, including, descriptions of food, shopping for food, cooking food, promoting food, different food service, and reviewing food. A creator role can create a poster, such as an uploaded image of food or food content with a description thereof. An album is also created, showing a collage of posters. An explorer role searches the network for content created by the creator role. The explorer discovers by searching the network and using keywords. The explorer can interact with other users and purchase food items. The explorer can also collect food items and follow other users.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to a social network. More particularly, the invention relates to a system and method for sharing food related content on a social network.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that having a healthy and balanced diet and making sound nutritional choices is an important part of healthy living. A balanced diet and variety of eating options can be enhanced by greater information about the food.

It is known that, food lovers are tuned in to food related topics. These food lovers may include chefs, foodies, restaurants, kitchen utensil suppliers, and reviewers. These people generally have a great interest in food and food related topics and are willing to spend resources to obtain this information. They can also provide information about food or food related topics that can benefit others.

Typically, within a social network, a set of users may create an event. For example, a user may create a listing for an event, such as a party, occurring at a specific date, time, and location, and may provide details about the event. Other users, such as contacts of the user, may comment on the event, such as an intent of a guest to attend or skip the event.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a flowchart diagram of an exemplary method for a food social network showing an exemplary creator role and an exemplary explorer role for a user, in accordance with an embodiment of the present invention;

FIGS. 2A and 2B illustrate screenshots for exemplary log in and personal account access operations, where FIG. 2A illustrates an exemplary log in screen with password, and FIG. 2B illustrates an exemplary personal account screen, in accordance with an embodiment of the present invention;

FIGS. 3A and 3B illustrate screenshots for exemplary creator roles, where FIG. 3A illustrates an exemplary create screen, and FIG. 3B illustrates an exemplary image that has been created, in accordance with an embodiment of the present invention;

FIGS. 4A and 4B illustrate screenshots for communicating with other users and editing items, where FIG. 4A illustrates an exemplary screen with multiple functions pertinent to communication with other users, and FIG. 4B illustrates an exemplary editing screen for editing the items, in accordance with an embodiment of the present invention;

FIG. 5 illustrates a screenshot of an exemplary item captured in the form of an image, including, item name, item description, and item price, in accordance with an embodiment of the present invention;

FIGS. 6A and 6B illustrate screenshots for exemplary explorer roles, where FIG. 6A illustrates an exemplary screen for interacting with the post by liking and clicking open to see the post and reveal items associated with the post, and FIG. 6B illustrates an exemplary discovery screen for viewing the items, in accordance with an embodiment of the present invention;

FIG. 7 illustrates a screenshot for interaction between an exemplary foodie user and another user who the foodie user has interest to communicate with, in accordance with an embodiment of the present invention;

FIGS. 8A and 8B illustrate screenshots for exemplary foodies to create and explore food related as an exemplary illustration of an old idea related to the system and method, where FIG. 8A illustrates an option for interactive dining, and FIG. 8B is a personal account dashboard for a foodie user, in accordance with an embodiment of the present invention;

FIG. 9 illustrates a flowchart diagram of an exemplary method for interaction between an exemplary chef and an exemplary consumer, in accordance with an embodiment of the present invention;

FIGS. 10A and 10B illustrate a relationship between an exemplary chef and an exemplary consumer, where FIG. 10A illustrates the chef serving as the host, and FIG. 10B illustrates the consumer serving as the host, in accordance with an embodiment of the present invention;

FIG. 11 illustrates a screenshot of an exemplary chef interaction opening screen, in accordance with an embodiment of the present invention;

FIG. 12 illustrates a screenshot of an exemplary calendar depicting the availability of the chef, in accordance with an embodiment of the present invention;

FIG. 13 illustrates a screenshot of an exemplary consumer verifying a date for the chef services, in accordance with an embodiment of the present invention;

FIG. 14 illustrates a screenshot of an exemplary interaction between the chef and the consumer, in accordance with an embodiment of the present invention;

FIG. 15 illustrates a screenshot of an exemplary reminder of an impending chef service, in accordance with an embodiment of the present invention;

FIG. 16 illustrates an exemplary scalable database system for an exemplary virtual platform implemented on an exemplary Web and an exemplary mobile application, in accordance with an embodiment of the present invention; and

FIG. 17 is a block diagram depicting an exemplary client/server system which may be used by an exemplary web-enabled/networked embodiment, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

The present invention will now be described in detail with reference to embodiments thereof as illustrated in the accompanying drawings.

There are various types of food social network systems and method that may be provided by preferred embodiments of the present invention. In one embodiment of the present invention, a system and method for a food social network shares a wide range of food related content between a network of users on a virtual platform. The system and method may integrate a variety of users who have an interest for food and food related content. The users may include a wide variety of food lovers, including, without limitation, interested viewers, bloggers, reviewers, shoppers, cookbook authors, and food related businesses.

The system and method covers everything from the actual food, to shopping for the food, to cooking the food, to promoting the food and food service, and even reviewing the food. This virtual interaction provides an all-inclusive food experience. The food may include, without limitation, specialty food, alcoholic drinks, non-alcoholic drinks, fresh produce, semi-prepared ingredients, and finished cuisine. The food related products may include without limitation, specialty foods, food gift sets, and cookware, cookbooks, cooking classes/education.

In one embodiment, the system may provide an online community shopping network for food and food related products. The system may form a virtual platform where users on the network can serve as shopping guides to other users on food and food related products. Each individual user may recommend products, teach users how to use the food related products, present their own creation from the products, and tell other users where and how to purchase the food. In essence, the system enables: 1) the creation of a social network platform; 2) promotion/sharing of food and food related products; and 3) promotion/sharing of food services.

In one embodiment, the system enables a user on the network to perform three general food related activities: community shopping, food social network, and interactive dining. The activities enable the user to: 1) serve as a shopping guide to other users in the community by posting images, videos, recipes, and online purchase links to recommend food items; 2) buy, share, and discover food and socialize with others in the community regarding the food experience; and 3) perform interactive dining by engaging in personal communication with chefs for cooking instructions and food customization, where the chefs are service providers and users are consumers in an online to brick-and-mortar dining experience. In any of the functions, the users may take the role of creating or viewing/interacting. In one embodiment an online to offline business model is used.

The system and method for sharing food related content on an online social network enables a foodie user to take the role of an explorer or a creator, share a wide range of food related content on a virtual platform, and interact with other users. The method covers numerous food related content, including, descriptions of food, shopping for food, cooking food, promoting food, different food service, and reviewing food. A creator role can create a poster, such as a downloaded image of food or food content with a description thereof. An album is also created, showing a collage of posters. An explorer role searches the network for content created by the creator role. The explorer discovers by searching the internet and using keywords. The explorer can interact with other users and purchase food items. The explorer can also collect food items and follow other users.

In some embodiments, the user may take the role of a creator or an explorer. The user selects the desired role while logging in to the system. Both roles are interchangeable, and a user may play both roles simultaneously. The user in the creator role provides the food related content for the system and edits the food related content. The food related content may include, without limitation, blogs, recipes, reviews, shopping sites, food related news, advertisements, promotions, and chef or food specialty business qualifications. In one embodiment, the creator can create a post or an album.

In some embodiments, the creator may create a post. Three steps may be taken in order for the creator to create the post. An initial step may include the creator submitting a picture onto the system. The picture may come from camera shot/upload from local computer/pin from any Internet source. A next step may include the creator editing information to describe the post, such as title, which album it belongs to, and tags for index or category use, if the food requires cooking, ingredients, cooking directions, cooking time, and general food related tips.

A final step for creating the post may include the creator arranging a plurality of items associated with the post. Since the items will later be presented to other users for purchase, to edit items at least include descriptions and sale information of the products. In some embodiments, the source of the items may be either from suppliers which have already been listed in the platform as sponsors or coordinated partners, or from any other merchants. Sometimes the item information is collected from other internet source without further editing, including picture, price, description etc., but we leave the edit option to users.

In some embodiments, the creator may also create an album. The album may include a plurality of posts combined into a collage of food related content. To create an album, the creator may edit posts first and combine them together, or choose multiple posts that already exist in the platform, and organize them in a way that creator thinks can best demonstrate ideas about the food related content. In some embodiments, the album may include, without limitation, a post with multiple pictures of food in the community shopping platform. An album can be a collection of posts, a collection of items, or a collection of posts and items combined.

As explained above, the user may also choose the explorer role, whereby the user does not provide food related content, but rather views and interacts with the food related content. In some embodiments, the explorer may discover and interact with the food related content for deciding on purchases or researching food related topics. The explorer discovers and interacts with the food related content. The explorer may view and interact with all available posts and food related content on the food social network. In some embodiments, the explorer discovers food related content by browsing all the possible food related content available on the platform. Due to various methods the food related content is organized, the explorer can browse in any of the following browsing techniques.

In some embodiments, the explorer may discovers food related content by interacting with other users on the food social network platform. The explorer may interact by collecting, buying, and interacting food related content with other users, including a chef. By collecting, the explorer may either collect a post, an album, or an item. The explorer may collect by performing the functions of like/save/add to a list with a single click. The collected information will appear in user's personal collection. To collect another user is simply to follow the other user. When that user appears in current user's collection list, current user will be able to read every piece of new posts from that user once the user logs in the account. This may include a news feed from other users.

By buying, the explorer can buy items online if that item contains purchase information. Since each post/album may contain more than one items when created, user has the freedom to buy either a single item or a whole set of items. By interacting with other users, the explorer can interact with other creators and explorers by following or exchanging messages with them. Following is identical to collecting by the explorer in collect activity, which is an one-way interaction. To exchange messages is to send and receive in-platform mails with another user. For example, the message exchange may be similar to online chatting if both users are online at the same time. Another way of interacting from an explorer with creators is to comment or give reviews to the creator's creations.

In some embodiments, the system may be efficacious for solving food related issues. The issues may include, without limitation, distribution of food related content for small businesses; providing food related needs for food lovers, such as foodies; and scalability of food and businesses from an on-line system to a brick and mortar business. In some embodiments, individual business users, such as a chef, may receive promotion on the food social network platform. For example, without limitation, the chef may post works along with other credentials on profiles to justify their professional qualifications. The chef may sell a service through the platform to other users in the network, including fans and followers. The system provides a strict methodology for a chef to promote services and credentials.

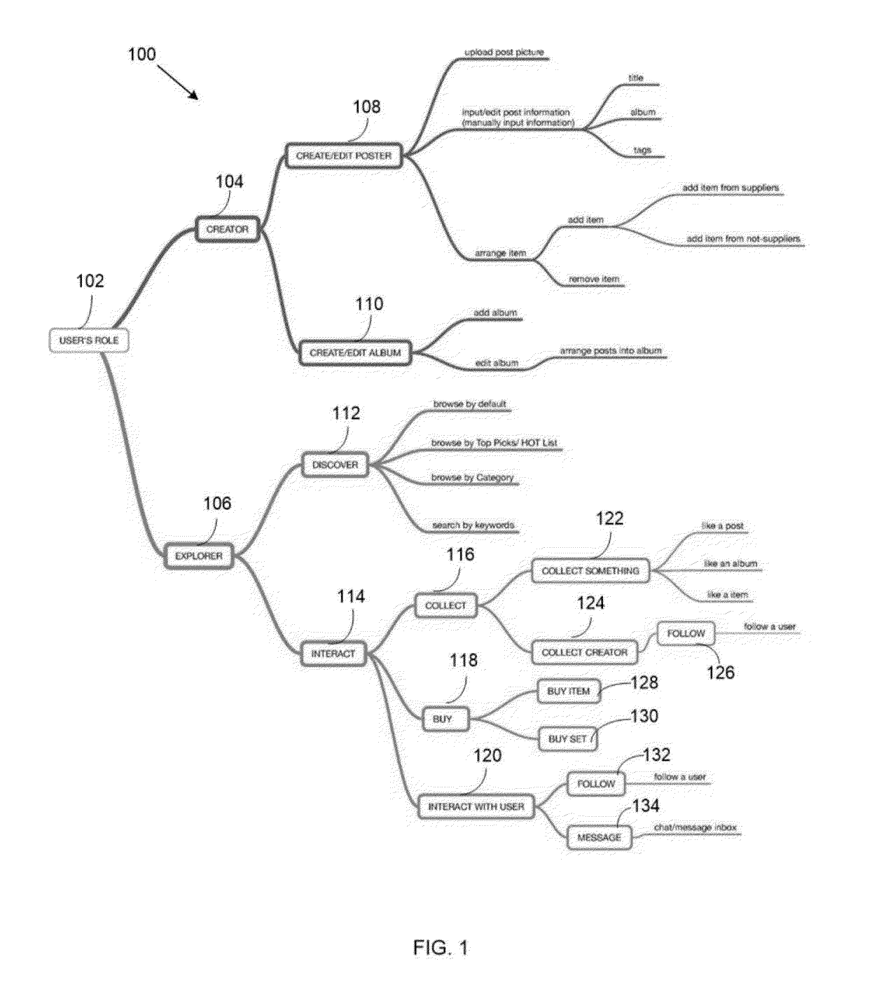

FIG. 1 illustrates a flowchart diagram of an exemplary method 100 for a food social network showing an exemplary creator role and an exemplary explorer role for a user, in accordance with an embodiment of the present invention. The method enables a foodie user to take the role of an explorer or a creator, share a wide range of food related content on a virtual platform, and interact with other users. The method covers numerous food related content, including, descriptions of food, shopping for food, cooking food, promoting food, different food service, and reviewing food. A creator role can create a poster, such as an uploaded image of food or food content with a description thereof. An album is also created, showing a collage of posters. An explorer role searches the network for content created by the creator role. The explorer discovers by searching the internet and using keywords. The explorer can interact with other users and purchase food items. The explorer can also collect food items and follow other users.

The method 100 enables a foodie user to take the role of an explorer or a creator, and share a wide range of food related content between networks of users on a virtual platform, and also to interact with other users. This virtual interaction between the explorer, creator, and other users provides an all-inclusive food experience. The method 100 may cover numerous food related content, including, without limitation, descriptions of the food, shopping for the food, cooking the food, promoting the food, different food service, and reviewing the food. The food may include, without limitation, candies, snacks, condiments, preserves, bread, grains, nuts, seafood, fresh produce, semi-prepared ingredients, finished cuisine, alcoholic drinks, non-alcoholic drinks.

The food related products may include without limitation, specialty foods, food gift sets, and cookware, cookbooks, cooking classes, and food education. In some embodiments, the method may integrate a variety of users interested in food and food products. The users may include a wide variety of food lovers, including, without limitation, foodies, interested viewers, bloggers, reviewers, shoppers, cookbook authors, and food related businesses. Each user may benefit from the interaction with fellow food lovers. In one alternative embodiment, the method may be used by any number of organizations, including, without limitation, wineries, breweries, wine lovers, beer lovers, artist(create promotion pictures/ads, design brand/food related fashion or arts), photographer (taking pictures), artisan food designers.

In some embodiments, the method may enable a user on the network to perform three general food related activities: community shopping, food social network, and interactive dining. The activities enable the user to: 1) serve as a shopping guide to other users in the community by posting images, videos, recipes, and online purchase links to recommend food items; 2) buy, share, and discover food and socialize with others in the community regarding the food experience; and 3) perform interactive dining by engaging in personal communication with chefs for cooking instructions and food customization, where the chefs are service providers and users are consumers in an online to brick-and-mortar dining experience. In any of the functions, the users may take the role of creating or viewing/interacting.

In one embodiment, the method 100 may provide an online community shopping network for food and food related products. The system may form a virtual platform where users on the network can serve as shopping guides to other users on food and food related products. Each individual user may recommend products, teach users how to use the food related products, present their own creation from the products, and tell other users where and how to purchase the food. In essence, the system enables: 1) the creation of a social network platform; 2) promotion/sharing of food and food related products; and 3) promotion/sharing of food services.

In another embodiment, the method 100 may utilize a virtual platform where a community of like-minded users can shop and enhance their dining experience by sharing food related information. The food related information may include, without limitation, recipes, nutritional facts, restaurant reviews, grocery store reviews, organic and local food sources, food news, and other general food related topics. Food related businesses may promote and sell food related content. For example, foodies may learn more about foods and food related businesses; and chefs may advertise meals and qualifications and sell cooking services. It is also significant to note that kitchen utensils and beverages, including alcoholic beverages, may also be displayed, narrated, and sold as food content.

In some embodiments, the method 100 may include a first Step 102 of selecting a role within the network. The network may include a food content social network, where users may exchange ideas, advice, and recipes about food, and also purchase food related items and literature. The users may choose between a creator role and an explorer role while using the method. The selected role determines whether the user is the more active creator role (provider of food related content), or the more passive explorer role (receiver of food related content) of food related content. However, either role may interact with the other.

A next Step 104 comprises following the creator role. The creator role generally adds food content to the method. A user in the creator role may provide the food related content for the system and edit the food related content. The food related content may include, without limitation, blogs, recipes, reviews, shopping sites, food related news, advertisements, promotions, and chef or food specialty business qualifications. In one embodiment, the creator role enables the user to create a post or an album. If the creator role is not selected, a Step 106 comprises following the explorer role. The explorer role views and interacts with the food content and other users. The explorer may choose to discover food content or interact with the creator or other food related sites.

A Step 108 may include creating or editing, by the creator role, a poster. The poster may depict an image or representation of the food or food related product. In some embodiments, the post may be created in three steps. The creator role initially submits an image. The image can come from camera shot/upload from local computer/pin from any Internet source. Then the creator role may edit information about the image to describe the post, such as title, ingredients, cooking directions, which album it belongs to, tags for index. Finally, the creator role may arrange items associated with the post. Since the items will later be presented to other users for purchase, to edit items at least include picture of the items, descriptions and sale information of the products. The source of items may be either of the two: from suppliers which have already been listed in the platform as sponsors or coordinated partners, or from any other merchants.

A Step 110 may include creating or editing, by the creator role, an album. The album may include a collage of posters. The creator role has the option of how many posters are collected. Each image or poster may be grouped by category. To create an album, the creator role may edit posts/items first and combine them together, or choose multiple posts/items that already exist in the platform, and organize them in a way that the creator role best demonstrates the intended idea.

In some embodiments, a Step 112 may include discovering, by the explorer role, the food related content. The explorer role may discover through various means, including, without limitation, browsing by default, browsing by top picks/hot list, browsing by category, and searching by keywords. A Step 114 comprises interacting, by the explorer role, with the food related content and other users. In some embodiments, the explorer role may interact with a post by submitting a re-creation of the post. The re-creation can be a copycat of the original post, a new creation from the original recipe, or a new creation from the same items. Such a submission among multiple users usually happen in a contest of cooking or promotion. The user may also suggest tags and vote for tags for each post for categorization purpose. For example, if a user thinks the cuisine in one post is Spanish cuisine and use seafood, the user can suggest a new tags, such as “Spanish” and “seafood”, and other users can vote if they share the same opinion. This helps system to organize contents with the help of community intellect.

In some embodiments, the interaction is virtual and in real time. The interaction may include a Step 116 of collecting food related content. The interaction may further comprises a Step 118 of buying food related content. The interaction may further include a Step 120 of interacting with other users. While performing the Step 116 of collecting food related content, the explorer role may perform the Step 122 of collecting an item or a post. However, the explorer role may also choose to perform a Step 124 of collecting another user in the network, at which time the explorer role becomes a follower of the other user. The Step 124 of collecting may include, without limitation, following a food blog, a recipe author, or a grocery store specials listing. In some embodiments, Step 124 is followed by a Step 126 of the explorer following the collected user.

In some embodiments, while following Step 118 of buying the food content, the explorer role may perform a Step 128 of buying a single item, or a Step 130 of buying a set of the food related content or items. Finally, when performing Step 120 of interacting with other users, the explorer role may perform a Step 132 of following the other user, or a Step 134 of communicating with the other user. The communication may include, without limitation, chatting, messaging, texting, and the like. In any case, the method 100 provides an interactive network for food lovers and food businesses to exchange ideas and information about food and food related content.

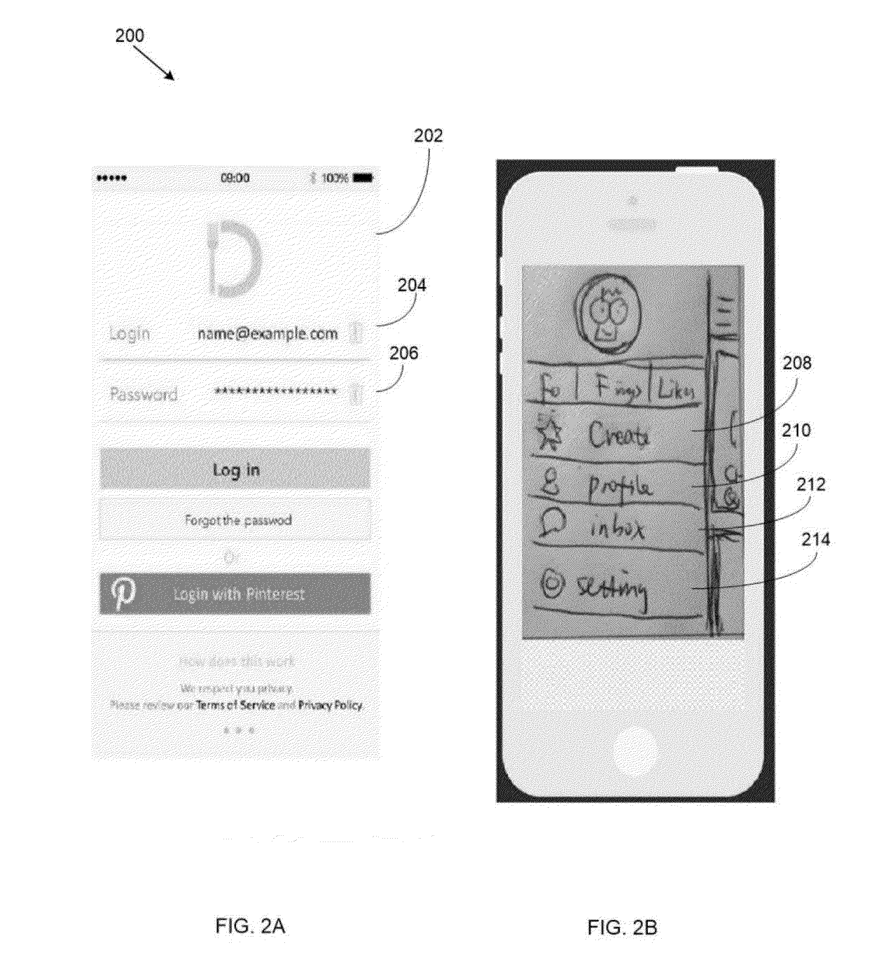

FIGS. 2A and 2B illustrate screenshots for exemplary log in and personal account access operations for a system for a food social network, where FIG. 2A illustrates an exemplary log in screen with password, and FIG. 2B illustrates an exemplary personal account screen, in accordance with an embodiment of the present invention. In the present invention, a system 200 for a food social network may allow the user take the role of a creator or an explorer. The user selects the desired role while logging in to the system, often in a log in screen 202. The log in screen may include a user name portion 204 for identifying the user and a password portion 206 for added security. Both the creator and explorer roles are interchangeable, and a user may play both roles simultaneously. In some embodiments, the online sales and promotion and community activities can be extended to offline events and becomes part of the community or sub-community based on interest and physical location.

The user in the creator role may provide the food related content for the system and edit the food related content. The food related content may include, without limitation, blogs, recipes, reviews, shopping sites, food related news, advertisements, promotions, and chef or food specialty business qualifications. In one embodiment, the creator can create a post or an album. In some embodiments, the initial screen may include an option for creating a food related content 208, creating a profile 210, an inbox portion 212 for interacting, and a settings portion 214 for setting the parameters of the system.

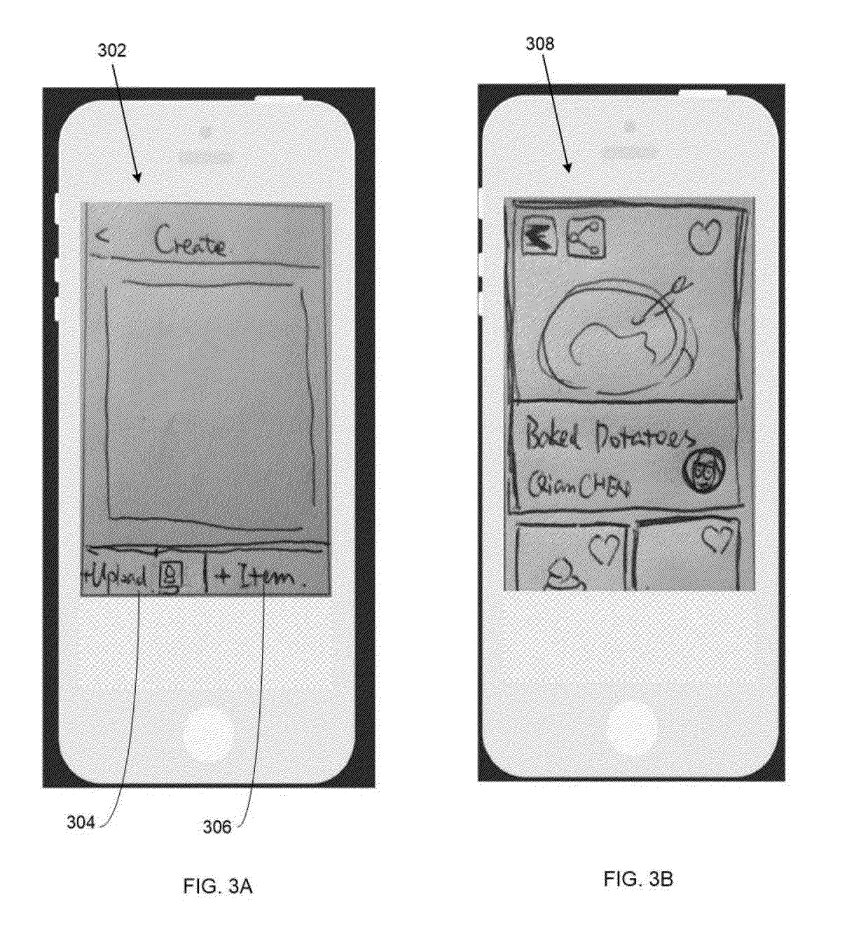

FIGS. 3A and 3B illustrate screenshots for exemplary creator roles, where FIG. 3A illustrates an exemplary create screen, and FIG. 3B illustrates an exemplary image that has been created, in accordance with an embodiment of the present invention. In the present invention, the creator may create a post, or single image of a food related content on a creator screen 302. In some embodiments, the create screen may include an upload portion 304 for uploading images from an external data storage or the Internet. The creator screen may also include an Add Item portion 306 for adding items to create a potential album. In some embodiments, three steps may be taken in order for the creator to create the post. An initial step may include the creator capturing a image 308 onto the system, as depicted in FIG. 3B. The image may come from camera shot/upload from local computer/pin from any Internet source. The image is viewable by other users, especially explorers, in the network.

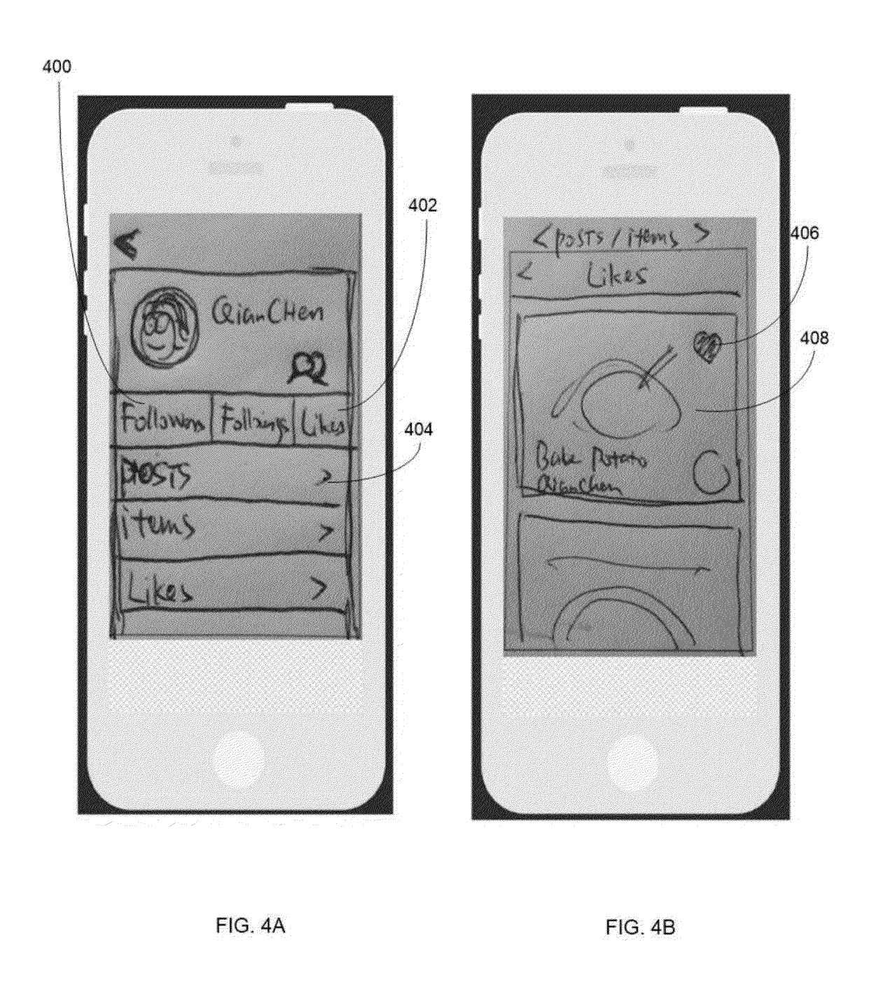

FIGS. 4A and 4B illustrate screenshots for communicating with other users, where FIG. 4A illustrates an exemplary screen with multiple functions pertinent to communication with other users, and FIG. 4B illustrates an exemplary editing screen for editing the items, in accordance with an embodiment of the present invention. In one aspect, FIG. 4A may include a browser showing another user's information when logging in. When a post from another user is opened, and the other user's personal information is opened, the number of followers, likes, and creations made in the past is made visible. Also, what that user likes or dislike is also shown. Communication may be initiated with a communication function switch, which may be proximal to an image of the other user. For example, without limitation, FIG. 4A shows the user Qian Chen. By selecting the communication function switch, a conversation may be initiated through online chatting or messaging with Qian Chen. Questions and advice may then be exchanged.

As shown in FIG. 4B, the next step for creating a post or album may include the creator editing information to describe the post, such as title, tags for index, ingredients, cookware used, cooking directions. A follow portion 400 may allow the user to follow other users and edit the respective food related content. An approval portion 402, such as a like button, may be used to indicate positive approval of the food related content. A post portion 404 may enable the user to display a post for further editing. After the food related content displays, an approval symbol 406, such as a heart shape, may indicate approved food relate content 408. In some embodiments, software for editing may include image post-processing tools to edit submitted pictures, video processing tools to edit submitted videos, or use external video links from website, including, without limitation, youtube/youku.com/tudou.com/vimeo.

A final step for creating the post may include the creator arranging a plurality of items associated with the post. Since the items will later be presented to other users for purchase, to edit items at least include descriptions and sale information of the products. In some embodiments, the source of the items may be either from suppliers which have already been listed in the platform as sponsors or coordinated partners, or from any other merchants.

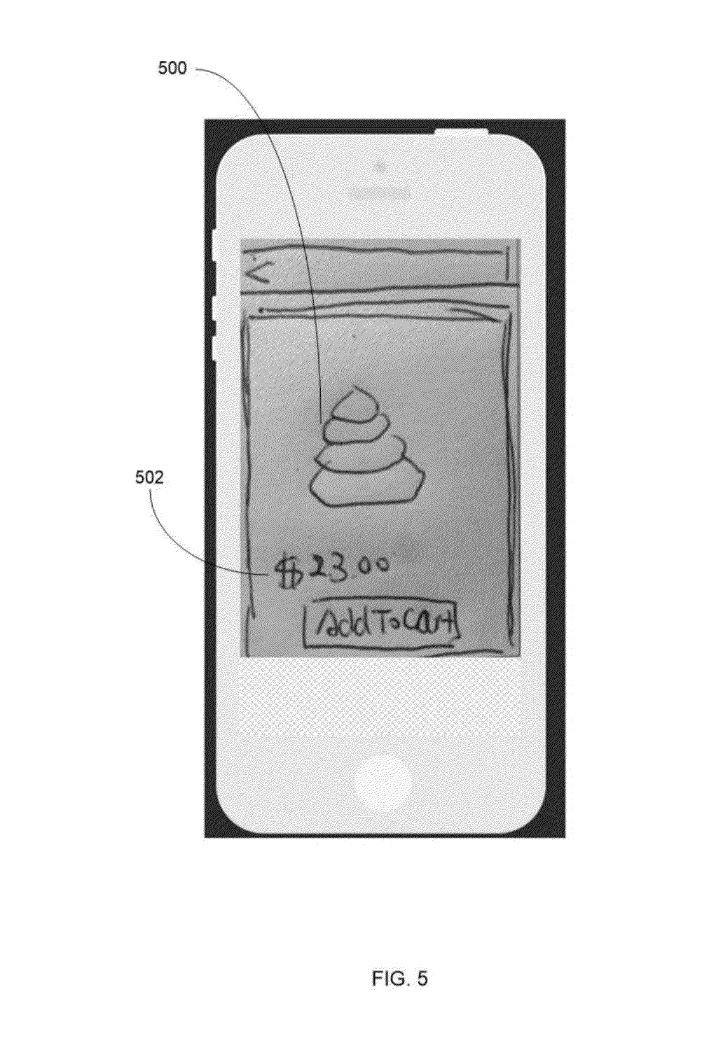

FIG. 5 illustrates a screenshot of an exemplary item captured in the form of an image, including, item name, item description, and item price, in accordance with an embodiment of the present invention. In one aspect, the plurality of items 500 may take various formats including, without limitation, text, picture, video, audio. However, the item may also be an object rather than an image. Also, each item does not necessarily link to B2C online purchase page. The item can be pure information to guide users where and how to buy the items, anywhere from local stores, restaurants to online shopping website. In some embodiments, the items may include, without limitation, a unit of food/drinks/food related product associated with a set. Each item may be presented in the format of picture, and directs to a B2C transaction page where users may view and/or purchase the items online A price portion 502 may also indicate the cost for purchasing the items.

In some embodiments, the creator may also create an album. The album may include a plurality of posts combined into a collage of food related content. To create an album, the creator may edit posts first and combine them together, or choose multiple posts that already exist in the platform, and organize them in a way that creator thinks can best demonstrate ideas about the food related content. In some embodiments, the album may include, without limitation, a post with multiple pictures of food in the community shopping platform. When editing an album, the user may freely combine pictures from other sets and newly submitted ones. Likewise, the user may provide ingredients, recipe, directions, and comments in text or other format to describe the album. The editing of the album is usually, though not necessarily true, based on a user defined theme. An album can be a collection of posts, a collection of items or a collection of posts and items combined.

As explained above, the user may also choose the explorer role, whereby the user does not provide food related content, but rather views and interacts with the food related content. In some embodiments, the explorer may discover and interact with the food related content for deciding on purchases or researching food related topics. The explorer discovers and interacts with the food related content. The explorer may view and interact with all available posts and food related content on the food social network.

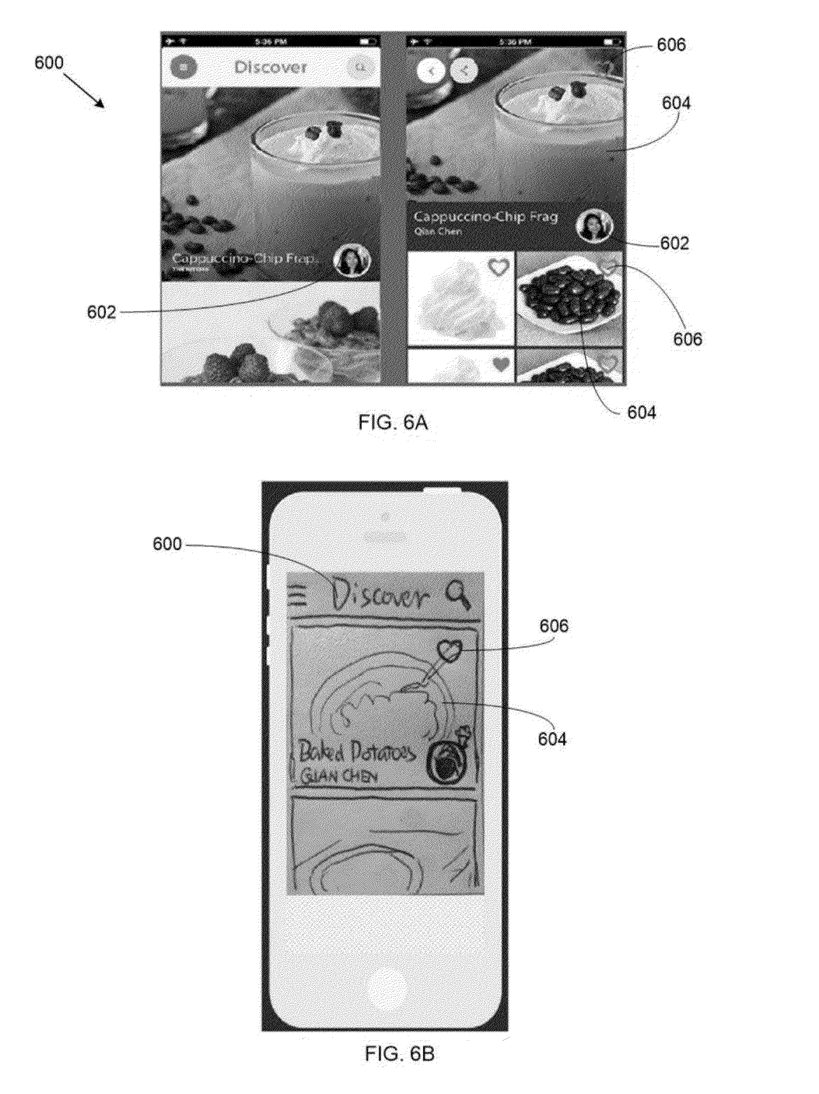

FIGS. 6A and 6B illustrate screenshots for exemplary explorer roles, where FIG. 6A illustrates an exemplary screen for interacting with the post by liking and clicking open to see the post and reveal items associated with the post, and FIG. 6B illustrates an exemplary discovery screen for viewing the items, in accordance with an embodiment of the present invention. In one aspect, a discovery screen 600 displays the food related content being discovered by an explorer 602. The explorer discovers food related content by browsing all the possible food related content available on the platform. In one embodiment, a discovered item 604 may be found, viewed, analyzed, and rated with an approval symbol 606 by the explorer. The explorer may discover the discovered item by browsing through the network or by search engine within the platform. However, due to the various methods that the food related content is organized, the explorer may browse by any of the following browsing techniques.

In some embodiments, the user may browse by default. In this browsing technique posts and albums are organized by a pre-defined algorithm. When the explorer logs in and enter homepage, the explorer is browsing by default. The browser may browse by top picks/hot lists. In some embodiments, platform runners may pick some trending topics or posts everyday and list them somewhere on homepage. If the explorer wants to see what's hot on the platform at this moment, the explorer may simply click these top picks/lists.

In some embodiments, the user may browse for the food content. If the explorer is particularly interested in reading information of a certain food category, the explorer may simply click the name of the category listed somewhere on a homepage, and browse the food related content dedicated to that category.

In some embodiments, the user may browse by keywords. If the explorer is particularly interested in reading information of one topic, the explorer can input the keywords best describes the topic and search on the platform. The return results are all edits containing those particular keywords, which are added as tags when other creators in the network create the contents. In some embodiments, the user may browse by feeds. If the explorer has followed other users, the user may read all the content created or collected from the followed users.

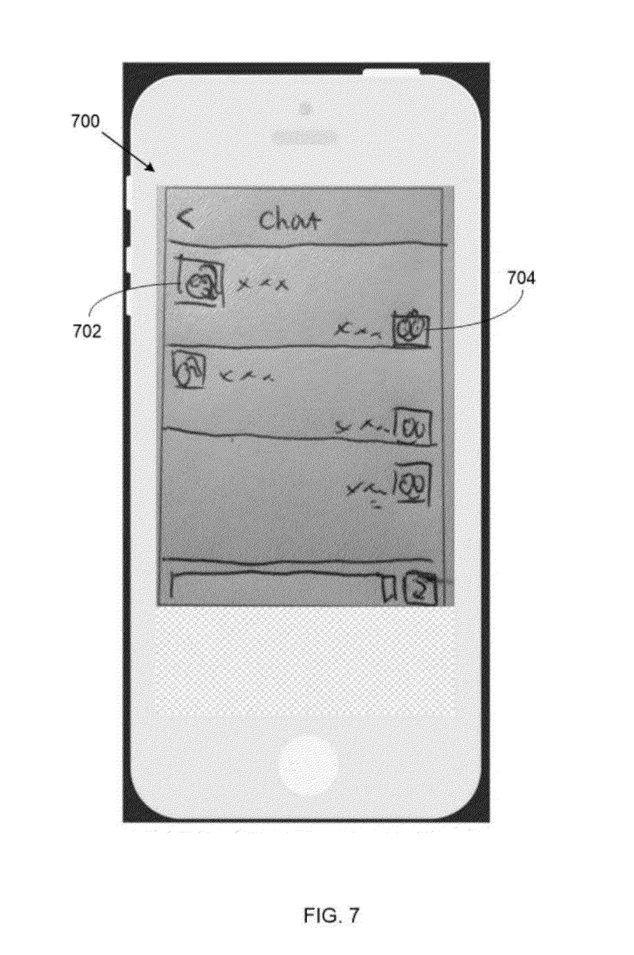

FIG. 7 illustrates a screenshot for interaction between an exemplary foodie user and another user who the foodie user has interest to communicate with, in accordance with an embodiment of the present invention. In one aspect, the explorer may discover food related content by interacting with other users on the food social network platform. The explorer interacts by collecting, buying, and interacting food related content with other users, including a chef.

By collecting, the explorer may either collect a thing or another user. The the explorer can collect a post, an album, or an item. The explorer may collect by performing the functions of like/save/add to a list with a single click. The collected information will appear in user's personal collection. To collect another user is simply to follow the other user. When that user appears in current user's collection list, current user will be able to read every piece of new posts from that user once the user logs in the account.

By buying, the explorer may buy items online if that item contains purchase information. Since each post/album may contain more than one items when created, user has the freedom to buy either a single item or a whole set of items. By interacting with other users, the explorer may interact with other creators and explorers by following or exchanging messages 700 with the users. In one embodiment, a first user 702 and a second user 704 may chat about a food related content of mutual interest. To exchange messages is to send and receive in-platform mails with another user. For example, the message exchange may be similar to online chatting if both users are online at the same time. Additionally, the user may follow another user, which is identical to collecting by the explorer in collect activity.

In some embodiments, the system may be useful for solving food related issues. The issues may include, without limitation, distribution of food related content for small businesses; providing food related needs for food lovers, such as foodies; and scalability of food and businesses from an on-line system to a brick and mortar business. The first issue involves small businesses, such as specialty food suppliers, that concentrate in a small business area and which have tight budget for marketing.

Those skilled in the art, in light of the present teachings, will recognize that although many of the specialty food suppliers have their own B2C website for product promotion and sales, they are seldom known to public. Many of the smaller specialty food suppliers may struggle to find cheap but efficient way for product promotion. The specialty food supplier may include, without limitation, specialty food supplier, personal chef, caterer, and a small restaurant.

The specialty food supplier may take the role of creator by posting or creating an album. For example editing a picture of fine cuisine made from the promoted products, and adding an item, such as pictures of individual promoted products to the set. In one embodiment, when an explorer, or any user on the network clicks to open the set, they can see how the set is made from items, and directly purchase items online by clicking “item”. Here, the specialty food supplier may become beneficiaries from the editing by obtaining sales and showcasing food related products and services with minimal marketing costs.

After the first initial promotion post from specialty food supplier, any user can re-create content from the promoted item, newly designed recipes, newly cooking works or newly discovered use of such item and promote such items. Furthermore, with a stimulus system that awards the best editor for their own products, every user on the network can promote their products and there is an amplifying effect to their sales. Those skilled in the art will recognize that since most users that utilize platform are food lovers, these food business will market up to the right group, making it more efficient than marketing on more general social networks, such as Facebook, Twitter, Tumbler, and the like.

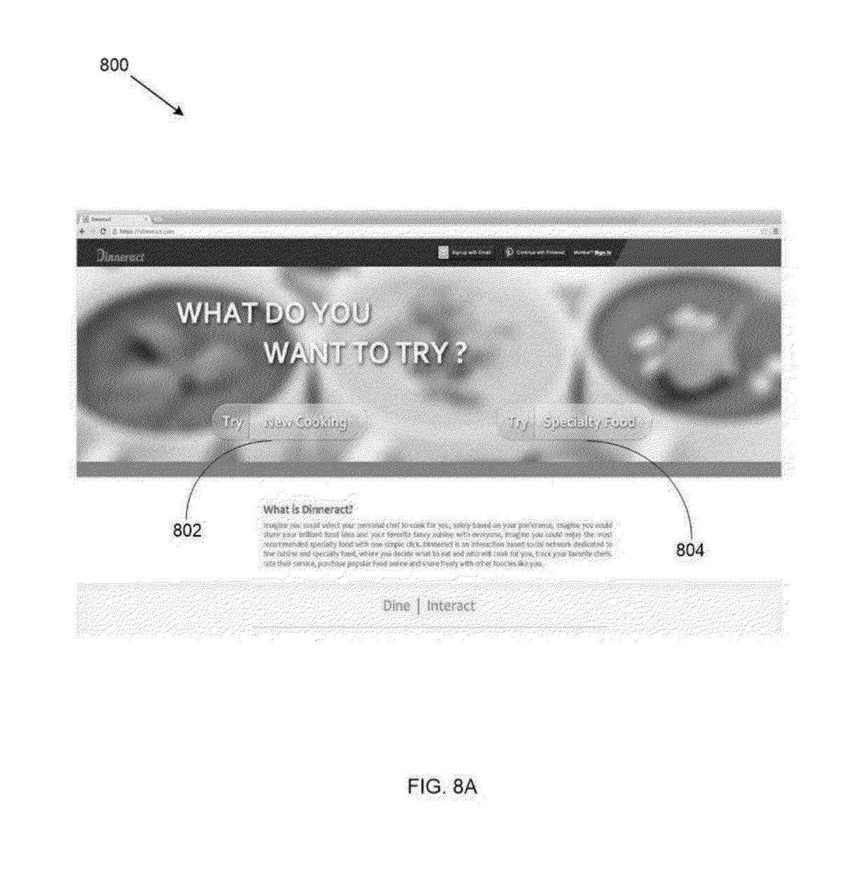

FIGS. 8A and 8B illustrate screenshots for exemplary foodies to create and explore food related as an exemplary illustration of an old idea related to the system and method, where FIG. 8A illustrates an option for interactive dining, and FIG. 8B is a personal account dashboard for a foodie user, in accordance with an embodiment of the present invention. In one aspect, the foodie user interacts with others, including, other foodies, chefs, or restaurant owners to discuss food and perform food related transactions.

In one embodiments, shown in FIG. 8A, a foodie user, clicks “try new cooking” leading to interactive dining where the can select any kind of fine cuisine (in picture) as well as a chef user the foodie user may want to do business with. The foodie user may send a dining request specifying the order details (cuisine picture, amount, when and where for delivery, price, any modification in the recipe, allergies etc.). The foodie user may then click “try specialty food” will lead to specialty food explorer page where he/she can search the specialty food by name/category, and he/she can purchase any specialty food item. FIG. 8B shows a personal account dashboard for the foodie user. The dashboard represents various personal information for the foodie user, including, without limitation: followers; followings; likes; news feed from other users that the foodie follows; and some new items recommended to the foodie user according to historic purchase data.

In some embodiments, the foodie user may be a creator or an explorer. As an editor, the foodie's role is similar to the aforementioned small business owner, which is to create content, edit the content, and add items. The editing is completely open, which encourages creativity. The foodies may upload their own cooking work, teach other users how to make cuisine, and guide other users where to buy the best ingredients. Additionally, the foodie may create recreational activities based on other user's previous works for editing an album of multiple posts. The album in this example for the foodie may include a collection of sets organized in a user defined theme, e.g. low fat diet, English afternoon tea etc. Every member in the network can be a shopping guide in this foodie community and contribute in their own style. Additionally, as an explorer, the foodie can discover new food and food ideas, share with one another and most importantly, purchase ingredients online that the foodie may wish to try at home. In summation, the food social network platform provides a perfect function integration of social and shopping for foodie

Another issue that the present system resolves may include scalability from an on-line system to a brick-and-mortar business. The system does not have proprietary food content. But rather, the system directs inquiries from users to the website for each business owner. Those skilled in the art, in light of the present teachings, will recognize that due to the strict regulation in food industry, the risk and the speed of expansion contradict each other for any online to brick-and-mortar service provider. For the present invention, it may not be necessary to screen the qualification of business users because online purchase to food suppliers are automatically directed to individual B2C webpage, and all business in specialty food industry are legitimate business owners. For international business users, regulation varies in each country which is beyond the scope of the present invention.

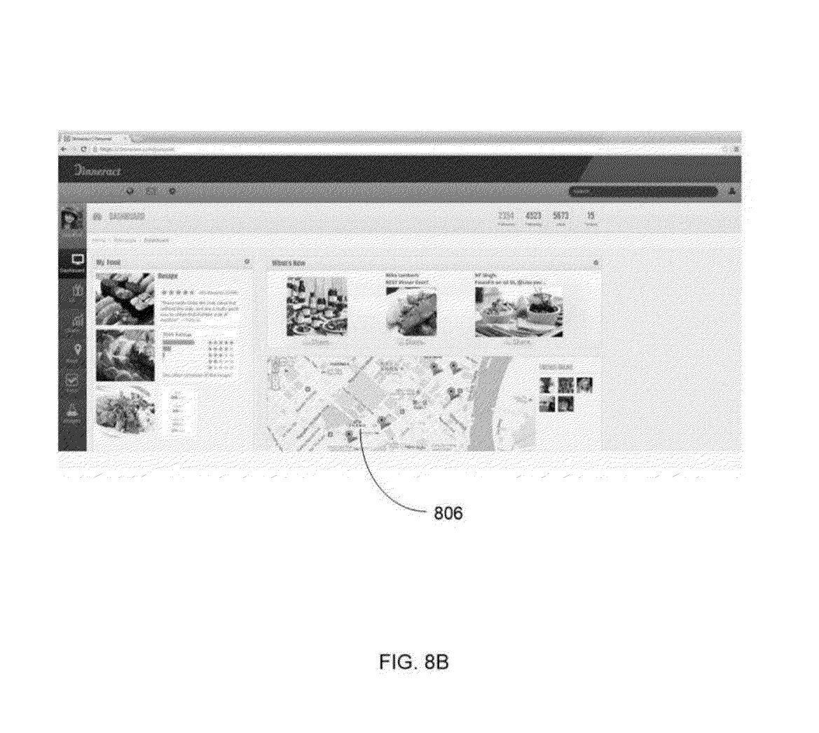

FIG. 9 illustrates a flowchart diagram of an exemplary method for interaction between an exemplary chef and an exemplary consumer, in accordance with an embodiment of the present invention. In the present invention, the method 900 for interaction between a chef and a consumer may enable efficient transactions and inexpensive promotion by a user 902, whether in the role of a chef 904 or a consumer 914 soliciting the services of the chef. The chef may receive promotion on the food social network platform. For example, without limitation, the chef may post works along with other credentials on profiles to justify their professional qualifications. The chef may sell a service through the platform to other users in the network, including fans and followers. The system provides a strict methodology for a chef to promote services and credentials.

In one example, to be recognized as legitimate cooking service provider, the chef may initially need to receive approval from a platform manager to open the feature that enables the chef to sell the service online. Chefs opening this feature may be marked explicitly on the platform in order for others to clearly identify their qualification. If a chef chooses not to open the feature to sell the service, the chef may be identified as a regular user 906, being able to create and to explorer. The chef who is in the role of the regular user may still create 908 and explore 910 in the network. If a regular user chef chooses to perform dining, the user may need to select an approved chef, and select a desired meal. The food choice can be either from chefs menu, or from the user's own creation (as a cluster of posts and albums). Hence, the selling party (approved chef) and buying party (user) has been identified in interactive dining on the platform. The two parties will interact in the following steps to make a dining service happen.

However, if a chef chooses to get approved and open the feature, the chef may show menus (as a cluster of posts and albums) and receive dining requests from potential diners as an approved chef 912. Similarly, the consumer may be a regular user 918 who creates 920 and explores 922. Or, if approved, the consumer may be a diner 916 who may interact with the chef as described below.

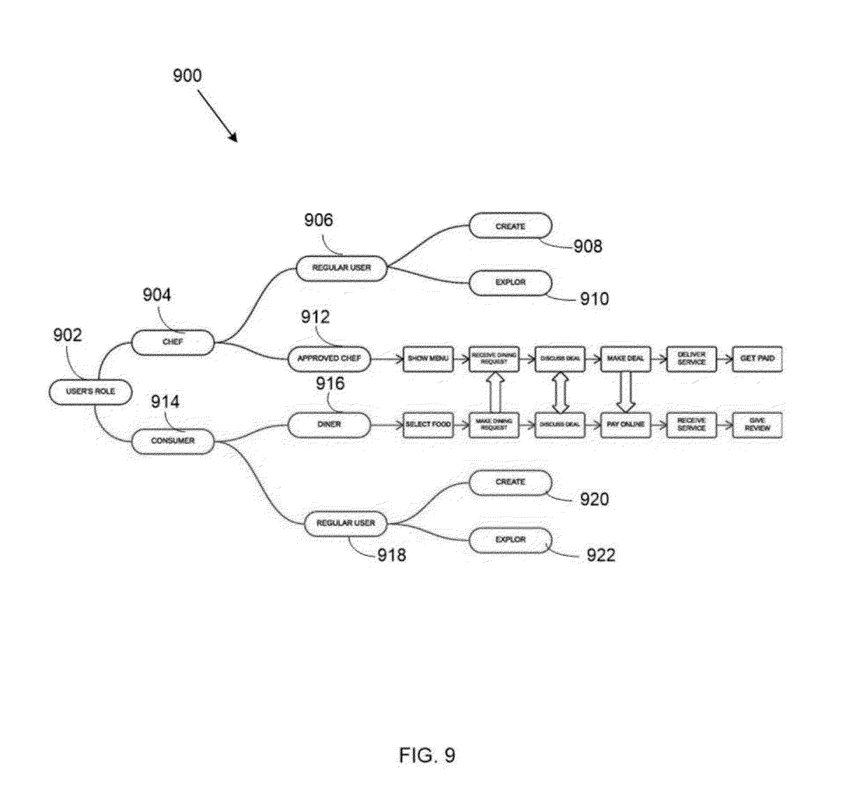

FIGS. 10A and 10B illustrate a relationship between an exemplary chef and an exemplary consumer, where FIG. 10A illustrates the chef serving as the host, and FIG. 10B illustrates the consumer serving as the host, in accordance with an embodiment of the present invention. In the present invention, a host chef 1000 may host a consumer 1002 for a culinary service. Additionally, a plurality of diners 1004 may be served by the host chef at the same time as the consumer. This may be the case, for example, at a restaurant. However, the cost may be too high for a host chef to cover, or the host chef may not have a place to host at. For example, a legal personal chef must have chef license or certificate, get liability insurance, and cook in commercial kitchens. Or the host chef, to avoid high cost of renting commercial kitchens, the may come to the client's residence and cook there.

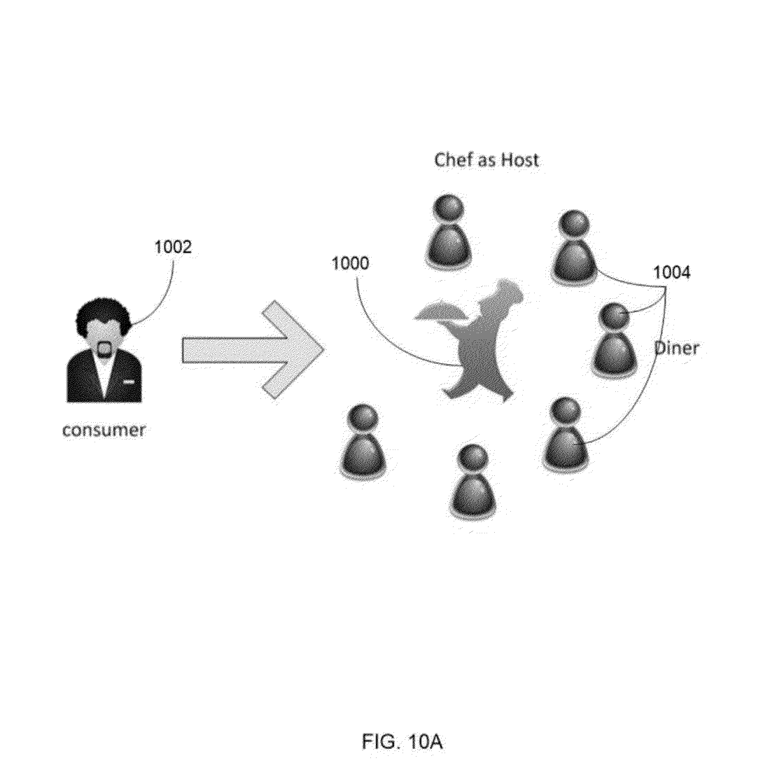

FIG. 11 illustrates a screenshot of an exemplary chef interaction opening screen, in accordance with an embodiment of the present invention. In the present invention, a chef interaction screen 1100 provides a platform for interaction between a chef and a consumer. First, the user may make a dining request to the chef, filling up the details like food choice, time, price range, before submitting the service and food related order.

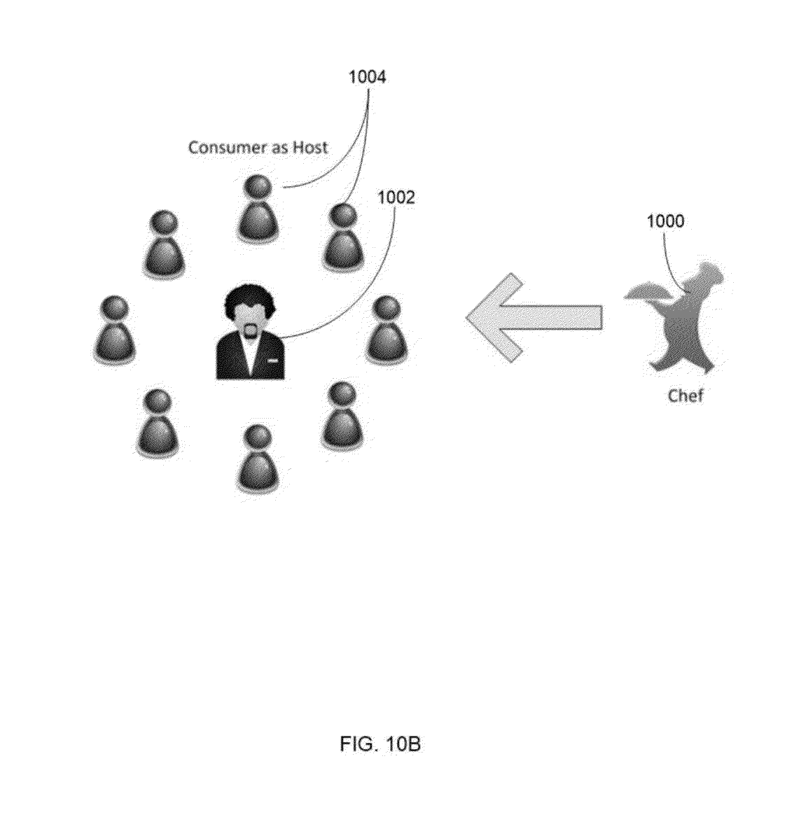

FIG. 12 illustrates a screenshot of an exemplary calendar depicting the availability of the chef, in accordance with an embodiment of the present invention. In the present invention, after the user selects the chef, a calendar 1200 may display. The calendar indicates the dates that the chef is available for performing the food related duties.

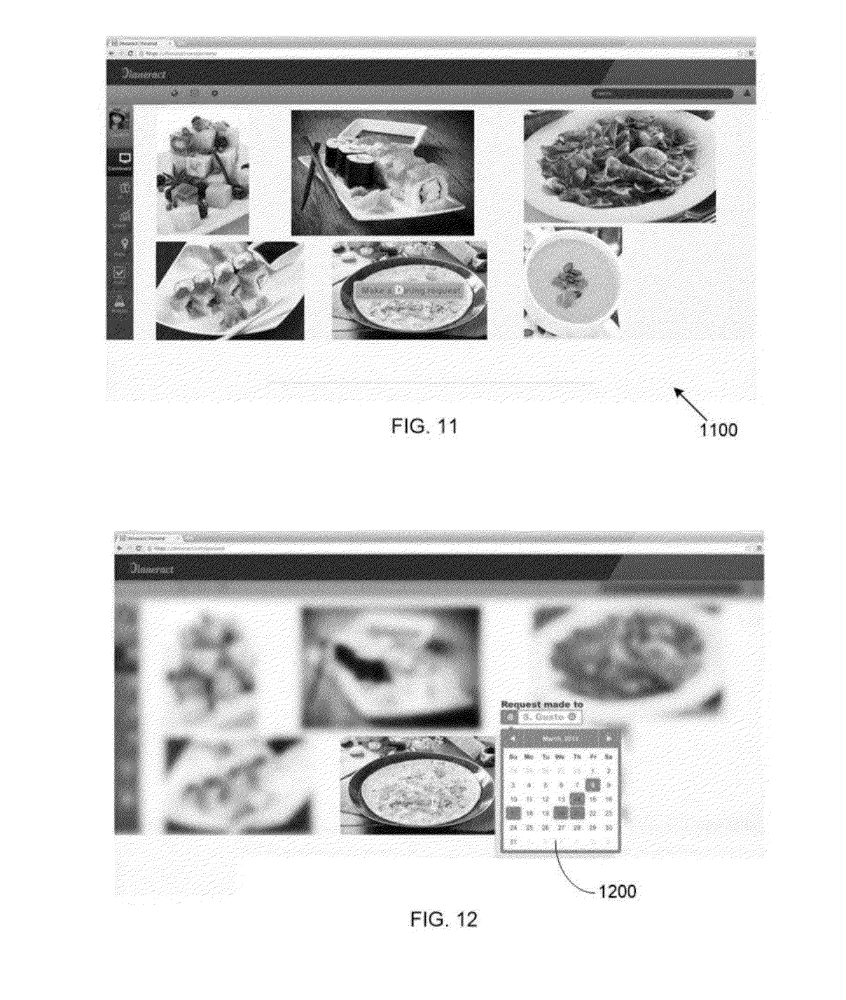

FIG. 13 illustrates a screenshot of an exemplary consumer verifying a date for the chef services, in accordance with an embodiment of the present invention. In the present invention, the user may select a desired date for the chef to provide the food related service. A date selection portion 1300 may include the day, month, and hour that is required for the service. A chat portion 1304 enables the user to request interaction with the chef. A finish request portion 1302 indicates that the user has completed with the order.

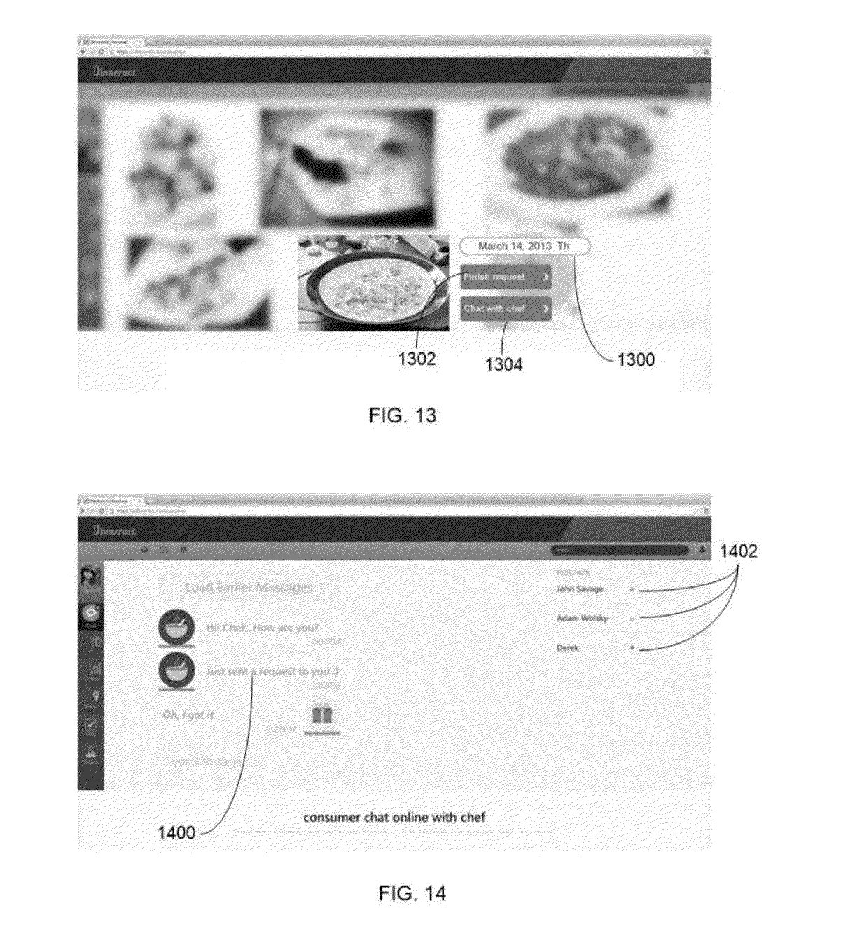

FIG. 14 illustrates a screenshot of an exemplary interaction between the chef and the consumer, in accordance with an embodiment of the present invention. In the present invention, the consumer and the chef may interact through an interaction medium 1400, such as a chat. For example, without limitation, when the chef receives the dining request from the diner, the chef and the user may discuss deals and other information related to the service being provided by the chef. In this manner, the user may narrow down more details through online chatting, or exchange messages if either party if offline. In another embodiment, additional diners 1402 may participate in the interaction medium to learn more about the chef or the service being provided.

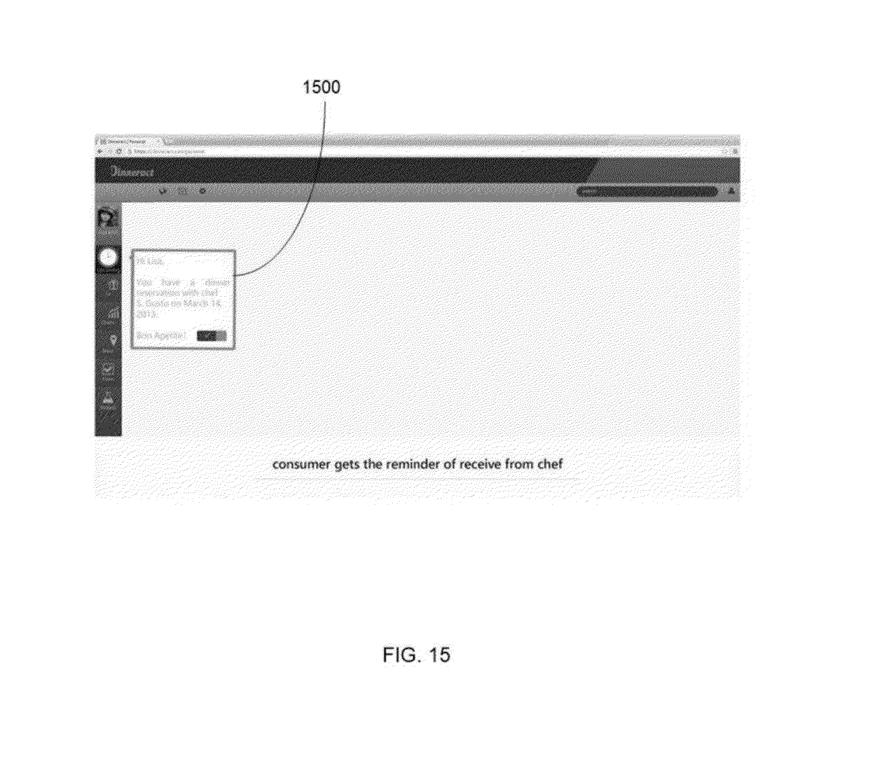

FIG. 15 illustrates a screenshot of an exemplary reminder of an impending chef service, in accordance with an embodiment of the present invention. In the present invention, the chef and/or the consumer may be reminded about the engagement through a reminder portion 1500, which may include an automated message. For example, the automated message may read, “Lisa, you have a dinner reservation with Chef on March 14.”

Once a deal is made, the chef may confirm with the user by sending a payment page, where the user can make online payment. The payment is temporarily pending to the chef until the service is completed. Then the chef delivers the cooking service based on the deal agreement, and the user receives the service. If any of the above step is not successful, the dining service is considered aborted. After the service is completed, the payment will be distributed to the chef, and user can give reviews and rating to the chef.

It is significant to note that, even though there are always a risk with online transactions, the user's long-term online relationship with the chef ahead of an offline service can greatly reduce the chance of misunderstandings or fraud. Furthermore, there is no local fourth wall preventing the scalability, the platform may expand worldwide fast without cost from us, the business runner of the platform.

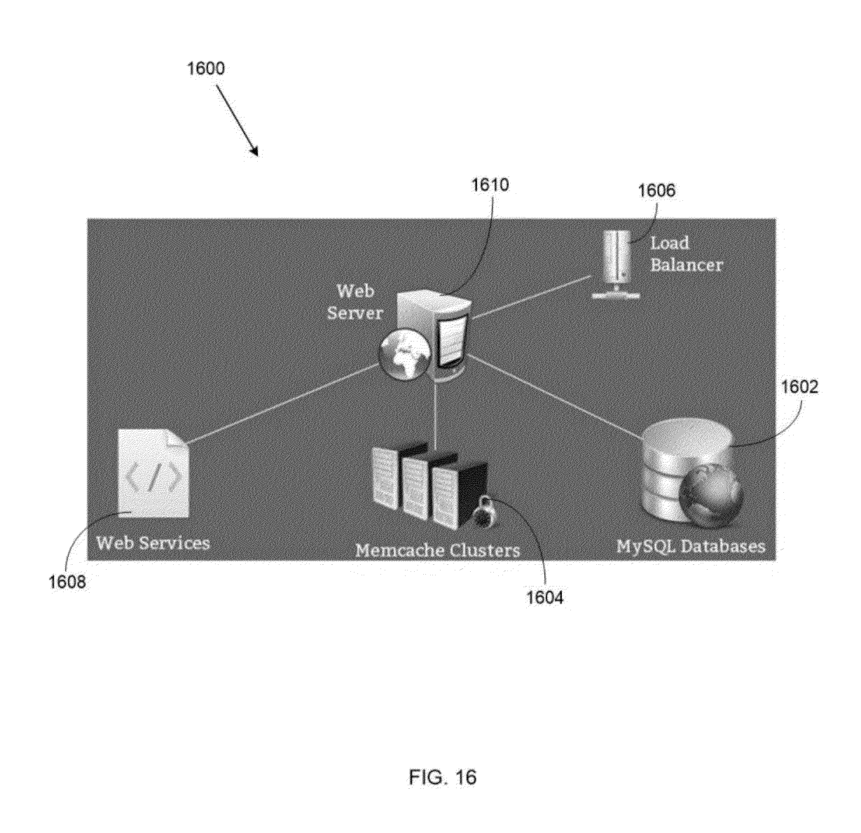

FIG. 16 illustrates an exemplary scalable database system for an exemplary virtual platform implemented on an exemplary Web and an exemplary mobile application. In the present invention, a scalable database system 1600 operatively connects different components of the network through a central Web server 1610 for transmitting data and connecting users in the network. In some embodiments, the mobile application may be implemented in JavaScript, and later it can run on both Mac and Android mobile systems. A large scalable database system may handle and process the large data in the most popular way as in other social networks like Facebook or Twitter.

In one embodiment, to speed up data operation for billions of users, a social network, such as Facebook may implement MySQL database 1602 and lot of cached data which they use dynamically. By cashing lot of user data many transactions are saved from occurring on Database in a second. The following are some of the Libraries which has made this possible[1]:

Memcached 1604 may include a general-purpose distributed memory caching system used by many sites including Facebook, Wikipedia, Flickr, Twitter, YouTube. Facebook uses this memory caching system to speed up dynamic database driven web pages by caching data and objects in RAM to reduce reading time from DB. Cache is a component that transparently stores data so that future requests for that data can be served faster. If user get logged in and active then Facebook loads all necessary information beside him on cache cluster and dynamically access this data.

Varnish 1606 is an HTTP accelerator designed for content-heavy dynamic web sites which can act as a load balancer and also cache content which can then be served lightning-fast. Varnish stores data in virtual memory and leaves the task of deciding what is stored in memory and what gets paged out to disk to the operating system. This helps avoid the situation where the operating system starts caching data while it is moved to disk by the application. Facebook uses Varnish to serve photos and profile pictures, handling billions of requests every day.

HipHop for PHP 1608 may include a series of PHP execution engines and improvements created by Facebook. The original motivation of HipHop was to save resources on Facebook servers, given the large PHP codebase of facebook.com. As development of HipHop progressed, it was realized that HipHop could substantially increase the speed of PHP applications.

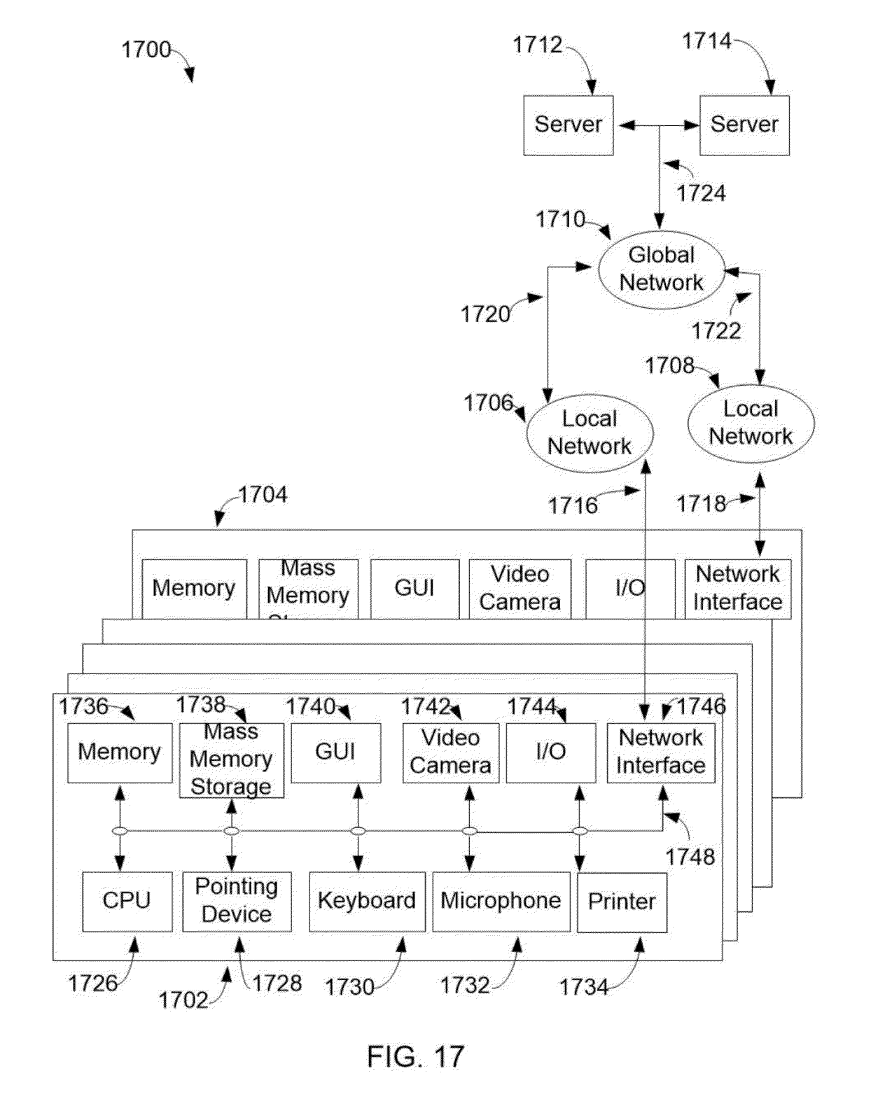

FIG. 17 is a block diagram depicting an exemplary client/server system which may be used by an exemplary web-enabled/networked embodiment of the present invention. A communication system 1700 includes a multiplicity of clients with a sampling of clients denoted as a client 1702 and a client 1704, a multiplicity of local networks with a sampling of networks denoted as a local network 1706 and a local network 1708, a global network 1710 and a multiplicity of servers with a sampling of servers denoted as a server 1712 and a server 1714.

Client 1702 may communicate bi-directionally with local network 1706 via a communication channel 1716. Client 1704 may communicate bi-directionally with local network 1708 via a communication channel 1718. Local network 1706 may communicate bi-directionally with global network 1710 via a communication channel 1720. Local network 1708 may communicate bi-directionally with global network 1710 via a communication channel 1722. Global network 1710 may communicate bi-directionally with server 1712 and server 1714 via a communication channel 1724. Server 1712 and server 1714 may communicate bi-directionally with each other via communication channel 1724. Furthermore, clients 1702, 1704, local networks 1706, 1708, global network 1710 and servers 1712, 1714 may each communicate bi-directionally with each other.

In one embodiment, global network 1710 may operate as the Internet. It will be understood by those skilled in the art that communication system 1700 may take many different forms. Non-limiting examples of forms for communication system 1700 include local area networks (LANs), wide area networks (WANs), wired telephone networks, wireless networks, or any other network supporting data communication between respective entities.

Clients 1702 and 1704 may take many different forms. Non-limiting examples of clients 1702 and 1704 include personal computers, personal digital assistants (PDAs), cellular phones and smartphones.

Client 1702 includes a CPU 1726, a pointing device 1728, a keyboard 1730, a microphone 1732, a printer 1734, a memory 1736, a mass memory storage 1738, a GUI 1740, a video camera 1742, an input/output interface 1744 and a network interface 1746.

CPU 1726, pointing device 1728, keyboard 1730, microphone 1732, printer 1734, memory 1736, mass memory storage 1738, GUI 1740, video camera 1742, input/output interface 1744 and network interface 1746 may communicate in a unidirectional manner or a bi-directional manner with each other via a communication channel 1748. Communication channel 1748 may be configured as a single communication channel or a multiplicity of communication channels.

CPU 1726 may be comprised of a single processor or multiple processors. CPU 1726 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 1736 is used typically to transfer data and instructions to CPU 1726 in a bi-directional manner. Memory 1736, as discussed previously, may include any suitable computer-readable media, intended for data storage, such as those described above excluding any wired or wireless transmissions unless specifically noted. Mass memory storage 1738 may also be coupled bi-directionally to CPU 1726 and provides additional data storage capacity and may include any of the computer-readable media described above. Mass memory storage 1738 may be used to store programs, data and the like and is typically a secondary storage medium such as a hard disk. It will be appreciated that the information retained within mass memory storage 1738, may, in appropriate cases, be incorporated in standard fashion as part of memory 1736 as virtual memory.

CPU 1726 may be coupled to GUI 1740. GUI 1740 enables a user to view the operation of computer operating system and software. CPU 1726 may be coupled to pointing device 1728. Non-limiting examples of pointing device 1728 include computer mouse, trackball and touchpad. Pointing device 1728 enables a user with the capability to maneuver a computer cursor about the viewing area of GUI 1740 and select areas or features in the viewing area of GUI 1740. CPU 1726 may be coupled to keyboard 1730. Keyboard 1730 enables a user with the capability to input alphanumeric textual information to CPU 1726. CPU 1726 may be coupled to microphone 1732. Microphone 1732 enables audio produced by a user to be recorded, processed and communicated by CPU 1726. CPU 1726 may be connected to printer 1734. Printer 1734 enables a user with the capability to print information to a sheet of paper. CPU 1726 may be connected to video camera 1742. Video camera 1742 enables video produced or captured by user to be recorded, processed and communicated by CPU 1726.

CPU 1726 may also be coupled to input/output interface 1744 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 1726 optionally may be coupled to network interface 1746 which enables communication with an external device such as a database or a computer or telecommunications or internet network using an external connection shown generally as communication channel 1716, which may be implemented as a hardwired or wireless communications link using suitable conventional technologies. With such a connection, CPU 1726 might receive information from the network, or might output information to a network in the course of performing the method steps described in the teachings of the present invention.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6).

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a social network having food related content according to the present invention will be apparent to those skilled in the art. Various aspects of the invention have been described above by way of illustration, and the specific embodiments disclosed are not intended to limit the invention to the particular forms disclosed. The particular implementation of the social network having food related content may vary depending upon the particular context or application. By way of example, and not limitation, the social network having food related content described in the foregoing were principally directed to a social network that enables users to view, edit, add content, and promote food and food related topics implementations; however, similar techniques may instead be applied to a network of wine lovers, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. One or more computer storage media storing computer-usable instructions, that when used by one or more computing devices, cause the one or more computing devices to perform a method comprising the steps of:
(a) selecting a role within a network;
(b) following a creator role;
(c) following an explorer role;
(d) creating or editing, by the creator role, a food related poster;
(e) creating or editing, by the creator role, an album, said album comprising a plurality of posters;
(f) discovering, by said explorer role, said food related content; and
(g) interacting, by said explorer role, with said food related content and at least one additional user.

2. The method of claim 1, in which said network comprises an online food content social network.

3. The method of claim 2, in which said food content comprises at least one food, said at least one food includes at least one member selected from the group consisting of: candies, snacks, condiments, preserves, bread, grains, nuts, seafood, fresh produce, semi-prepared ingredients, finished cuisine, alcoholic drinks, non-alcoholic drinks, and food preparation utensils.

4. The method of claim 3, wherein said creator role is configured to provide and edit food related content to said network.

5. The method of claim 4, wherein said explorer role is configured to discover said food related content and interact with said creator role.

6. The method of claim 5, in which Step (b) further includes creating or editing, by said creator role, a poster.

7. The method of claim 6, in which said poster comprises an image or representation of said food related content.

8. The method of claim 7, in which Step (b) further includes creating or editing, by said creator role, an album.

9. The method of claim 8, in which said album comprises a collage of posters.

10. The method of claim 9, wherein said poster and said album are organized by a pre-defined algorithm.

11. The method of claim 10, in which Step (c) further includes discovering, by said explorer role, said food related content.

12. The method of claim 11, wherein said discovering said food related content includes at least one member selected from the group consisting of: browsing by default, browsing by top picks, browsing by category, and searching by keywords.

13. The method of claim 12, in which Step (c) further includes interacting, by said explorer role, with said food related content and at least one additional user.

14. The method of claim 13, in which Step (g) further includes collecting said food related content.

15. The method of claim 14, in which said collecting said food related content comprises collecting a food item and/or collecting a creator role.

16. The method of claim 15, in which Step (g) further includes buying said food related content.

17. The method of claim 16, in which said buying said food related content comprises buying a food item and/or buying a set of food items.

18. The method of claim 17, in which Step (g) further includes interacting with said at least one additional user.

19. A system for sharing food related content on a network, said system comprising:
means for creating said food related content;
means for exploring said food related content;
means for interacting throughout said network between said creating means and said exploring means;
means for displaying said food related content by said creating means;
means for selling said food related content by said creating means;
means for collecting said food related content by said exploring means; and
means for buying said food related content by said exploring means.

20. A non-transitory program storage device readable by a machine tangibly embodying a program of instructions executable by the machine to perform a method for sharing food related content on a network, the storage device comprising:
computer code for selecting a role within a network;
computer code for following an explorer role;
computer code for creating or editing, by the creator role, a food related poster;
computer code for creating or editing, by the creator role, an album, said album comprising a plurality of posters;
computer code for discovering, by said explorer role, said food related content; and
computer code for interacting, by said explorer role, with said food related content and at least one additional user.
